(19) United States
(12) Patent Application Publication
(10) Pub. No.: US 2026/0058051 A1
(43) Pub. Date: Feb. 26, 2026

(54) SYSTEMS AND METHODS FOR ENHANCING LEAKAGE INDUCTANCE OF POWER TRANSFORMERS

(71) Applicant: Archer Aviation Inc., San Jose, CA (US)

(72) Inventors: Harshit SONI, Milpitas, CA (US); Stephen SPITERI, Livermore, CA (US)

(73) Assignee: Archer Aviation Inc., San Jose, CA (US)

(21) Appl. No.: 19/304,046

(22) Filed: Aug. 19, 2025

Related U.S. Application Data
(63) Continuation of application No. PCT/US24/28172, filed on May 7, 2024.
(60) Provisional application No. 63/464,668, filed on May 8, 2023.

(51) Int. Cl. H01F 27/36; H01F 27/02; H01F 27/28; H01F 30/16

(52) U.S. Cl. CPC H01F 27/361; H01F 27/027; H01F 27/2895; H01F 30/16

(57) ABSTRACT

The embodiments of the present disclosure provide systems and methods of forming a transformer with enhanced leakage inductance for power conversion. The transformer may include a toroidal core, a primary winding around a first portion of the toroidal core, a secondary winding around a second portion of the toroidal core different from the first portion, and a magnetic material disposed within a cavity formed by the toroidal core. The magnetic material may comprise a ferrite. The method of forming a transformer may include the steps of providing a toroidal core, winding a primary coil around a first portion of the toroidal core, winding a secondary coil around a second portion of the toroidal core, and disposing a magnetic material within the cavity formed by the toroidal core to enhance the leakage inductance of the transformer.

### CROSS-REFERENCE TO RELATED APPLICATIONS

This application is a continuation of Patent Cooperation Treaty Application No. PCT/US24/28172, filed May 7, 2024, which claims the benefit of priority from U.S. Provisional Application No. 63/464,668, filed May 8, 2023, the entire contents of which are expressly incorporated herein by reference.

### TECHNICAL FIELD

This disclosure relates generally to power converter systems. More particularly, and without limitation, the present disclosure relates to innovations in aircrafts driven by electric propulsion systems. Certain aspects of this disclosure generally relate to DC-DC power converter systems used in electric engines, gearboxes, and power inverters that provide particular advantages in aircrafts driven by electric propulsion systems and in other types of vehicles.

### BACKGROUND

The present disclosure addresses systems, components, and techniques primarily for use in a non-conventional aircraft driven by an electric propulsion system. For example, the tilt-rotor aircraft of the present disclosure may be configured for frequent (e.g., over 50 flights per workday), short-duration flights (e.g., less than 100 miles per flight) over, into, and out of densely populated regions. The aircraft may be configured to carry 4-6 passengers or commuters who have an expectation of a comfortable experience with low noise and low vibration. Accordingly, it may be desired that components of the aircraft are configured and designed to withstand frequent use without wearing, generate less heat and vibration, and that the aircraft include mechanisms to effectively control and manage heat or vibration generated by the components. Further, it may be intended that several of these aircraft operate near each other over a crowded metropolitan area. Accordingly, it may be desired that their components are configured and designed to generate low levels of noise interior and exterior to the aircraft, and to have a variety of safety and backup mechanisms. For example, it may be desired for safety reasons that the aircraft be propelled by a distributed propulsion system, avoiding the risk of a single point of failure, and that they are capable of conventional takeoff and landing on a runway. Moreover, it may be desired that the aircraft can safely vertically takeoff and land from and into relatively small or restricted spaces compared to traditional airport runways (e.g., vertiports, parking lots, or driveways) while transporting several passengers or commuters with accompanying baggage. These use requirements may place design constraints on aircraft size, weight, operating efficiency (e.g., drag, energy use), which may impact the design and configuration of the aircraft components.

Disclosed embodiments provide new and improved configurations of aircraft components that are not observed in conventional aircraft, and/or identified design criteria for components that differ from those of conventional aircraft. Such alternate configurations and design criteria, in combination addressing drawbacks and challenges with conventional components, yielded the embodiments disclosed herein for various configurations and designs of components for an aircraft driven by an electric propulsion system.

In some embodiments, the aircraft driven by an electric propulsion system of the present disclosure may be designed to be capable of both vertical and conventional takeoff and landing, with a distributed electric propulsion system enabling vertical flight, horizontal and lateral flight, and transition. Thrust may be generated by supplying high voltage electrical power to a plurality of electric engines of the distributed electric propulsion system, which may include the necessary components to convert the high voltage electrical power into mechanical shaft power to rotate a propeller. Embodiments disclosed herein may involve optimizing the energy density of the electric propulsion system. Embodiments may include an electric engine connected to an onboard electrical power source, which may include a device capable of storing energy such as a battery or capacitor, and may include one or more systems for harnessing or generating electricity such as a fuel powered generator or solar panel array. Some disclosed embodiments provide for weight reduction and space reduction of components in the aircraft to increase aircraft efficiency and performance. Disclosed embodiments also improve upon safety in passenger transportation using new and improved safety protocols and system redundancy in the case of a failure, to minimize any single points of failure in the aircraft propulsion system. Some disclosed embodiments also provide new and improved approaches to satisfying and exceeding aviation and transportation laws and regulations. For example, the Federal Aviation Administration enforces federal laws and regulations requiring safety components such as fire protective barriers adjacent to engines that use more than a threshold amount of oil or other flammable materials. A fire protective barrier may include an engine component or aircraft component designed, constructed, or installed with the primary purpose of being constructed so that no hazardous quantity of air, fluid, or flame can pass around or through the fire protective barrier and/or to protect against corrosion. In some embodiments, a fire protective barrier may include a component separate from additional components as recited herein. Persons of ordinary skill in the art would understand which components within an aircraft, including within an electric propulsion system, would act with the primary function of being a fire protective barrier. In some embodiments, a fire protective barrier may include a firewall, a fireproof barrier, a fire-resistant barrier, a flame-resistant barrier, or any other barrier capable of ensuring no hazardous quantity of air, fluid, or flame can pass around or through the barrier and/or to protect against corrosion. For example, while a fuselage may be constructed so that no hazardous quantity of air, fluid, or flame can pass around or through the fire protective barrier, and/or protect against corrosion, the fuselage may not be considered a fire protective barrier since the primary purpose of a fuselage is not to be a fire protective barrier. In some embodiments, electric propulsion systems provide for efficient and effective lubrication and cooling using less than the threshold level of oil, yielding an aircraft that does not require engine fire protective barriers, saving on aircraft weight while maximizing performance and efficiency.

In some embodiments, the distributed electric propulsion system may include twelve electric engines, which may be mounted on booms forward and aft of the main wings of the aircraft. A subset of the electric engines, such as those mounted forward of the main wings, may be tiltable mid-flight between a horizontally oriented position (e.g., to generate forward thrust for cruising) and a vertically oriented position (e.g., to generate vertical lift for takeoff, landing, and hovering). The propellers of the forward electric engines may rotate in a clockwise or counterclockwise direction. Propellers may counter-rotate with respect to adjacent propellers. The aft electric engines may be fixed in a vertically oriented position (e.g., to generate vertical lift). The propellers of the aft electric engines may also rotate in a clockwise or counterclockwise direction. In some embodiments, the difference in rotation direction may be achieved using the direction of engine rotation. In other embodiments, the engines may all rotate in the same direction, and gearing may be used to achieve different propeller rotation directions

In some embodiments, an aircraft may possess quantities of electric engines in various combinations of forward and aft engine configurations. For example, an aircraft may possess six forward and six aft electric engines, four forward and four aft electric engines, or any other combination of forward and aft engines, including embodiments where the number of forward electric engines and aft electric engines are not equivalent.

In some embodiments, for a vertical takeoff and landing (VTOL) mission, the forward and aft electric engines may provide vertical thrust during takeoff and landing. During flight phases where the aircraft is moving forward, the forward electric engines may provide horizontal thrust, while the propellers of the aft electric engines may be stowed at a fixed position in order to minimize drag. The aft electric engines may be actively stowed with position monitoring. Transition from vertical flight to horizontal flight and vice-versa may be accomplished via the tilt propeller subsystem. The tilt propeller subsystem may redirect thrust between a primarily vertical direction during vertical flight mode to a horizontal or near-horizontal direction during a forward-flight cruising phase. A variable pitch mechanism may change the forward electric engine's propeller-hub assembly blade collective angles for operation during the hover-phase, transition phase, and cruise-phase.

In some embodiments, in a conventional takeoff and landing (CTOL) mission, the forward electric engines may provide horizontal thrust for wing-borne take-off, cruise, and landing, and the wings may provide vertical lift. In some embodiments, the aft electric engines may not be used for generating thrust during a CTOL mission and the aft propellers may be stowed in place. In other embodiments, the aft electrical engines may be used at reduced power to shorten the length of the CTOL takeoff or landing.

The present disclosure addresses DC-DC power converter systems used in electric engines, gearboxes, and power inverters that provide particular advantages in aircrafts driven by electric propulsion systems and in other types of vehicles. Some of the currently existing topologies for DC-DC power conversion applications include half-bridge LLC converters (1 resonant inductor, 1 magnetizing inductor and 1 capacitor), full-bridge LLC converters, CLLLC converters (2 resonant inductors, 1 magnetizing inductor and 2 resonant capacitors), phase shifted full bridge, etc. In LLC topologies, resonance is established at the switching frequency and as a result, the switching transistors see a sinusoidal current and are enabled to switch at the zero crossing points or near zero, commonly known as zero voltage switching (ZVS). This, in turn has the effect of reduced switching losses in the transistors. In such topologies, the series inductor is realized using an extra component or part of the leakage inductance of the transformer. However, in some applications, the additional inductor may introduce myriad issues including, but not limited to, increased weight, increased likelihood of failure, more space consumption, and the like. To mitigate some of these issues, the leakage inductance of the transformer may be enhanced by, for example, employing different winding configurations, core designs, etc., which can act as an additional series inductor. In some applications, it may be beneficial to obtain and provide higher leakage inductance while maintaining high power conversion efficiency, compactness, light-weight, reliability, integratability, and cost-effectiveness.

### SUMMARY

The present disclosure generally relates to power converter systems with enhanced leakage inductance and methods thereof. Moreover, and without limitation, this disclosure relates to systems and methods of increasing leakage inductance of isolated DC-DC power converters for resonance and/or zero voltage switching (ZVS) applications in automobiles, electric vertical takeoff and landing (eVTOLs) aerial vehicles, engines, propellers, motors, and the like.

One aspect of the present disclosure is directed to a transformer of a power converter. The transformer may include a toroidal core, a primary winding around a first portion of the toroidal core, a secondary winding around a second portion of the toroidal core different from the first portion, and a magnetic material disposed within a cavity formed by the toroidal core. The first and the second portions of the toroidal core including the first and the second windings respectively, may be diametrically opposite from each other. The cavity may be filled with a magnetic material including a ferrite structure and the ferrite structure may include a ferrite bar, a ferrite rod, a ferrite shim, a plurality of ferrite bars, a plurality of ferrite rods, a plurality of ferrite shims, a T-shaped ferrite structure.

In some embodiments, the ferrite bar is located such that a geometric center of the ferrite bar aligns with a geometric center of the toroidal core. The length of the ferrite bar may be equal to an inner diameter of the toroidal core. The length of the ferrite bar may be smaller than an inner diameter of the toroidal core. The ferrite bar may be located such that an air gap is formed between an inner surface of the toroidal core and an edge of the ferrite bar.

In some embodiments, the ferrite structure may be a ferrite rod. A center of the ferrite rod may align with a geometric center of the toroidal core.

In some embodiments, the ferrite structure may comprise a plurality of ferrite bars. A first bar and a second bar of the plurality of ferrite bars may be disposed diametrically opposite to each other, and wherein the first and the second bars are separated by an air gap. The center of the air gap may align with a geometric center of the toroidal core.

In some embodiments, the ferrite structure may include a T-shaped structure, wherein a first portion may be disposed along a first plane perpendicular to a central axis of the toroidal core; and a second portion may be disposed along a second plane parallel to the central axis and extending along a depth of the cavity. The length of the first portion of the ferrite structure may be greater than the inner diameter of the toroidal core.

In some embodiments, the toroidal core and the ferrite structure may be fabricated from a monolithic ferrite substrate. The toroidal core and the ferrite structure may be additively manufactured using a 3-D printing technique.

Another aspect of the present disclosure is directed to a method of forming a transformer, the method may include providing a toroidal core, winding a primary coil around a first portion of the toroidal core, winding a secondary coil around a second portion of the toroidal core different from the first portion, and disposing a magnetic material within a cavity formed by the toroidal core, wherein the magnetic material in the cavity enhances a leakage inductance of the transformer.

Another aspect of the present disclosure is directed to a transformer of a power converter. The transformer may include a first toroidal core, a primary winding around a first portion of the first toroidal core, a secondary winding wound around a second portion of the first toroidal core different from the first portion, and a second toroidal core disposed within a cavity of the first toroidal core. The second toroidal core may be unwound.

Another aspect of the present disclosure is directed to a transformer of a power converter. The transformer may include a first toroidal core, a primary winding around a first portion of the first toroidal core, a secondary winding wound around a second portion of the second toroidal core different from the first portion, and a second toroidal core around the first toroidal core, wherein the first toroidal core is located within a cavity of the second toroidal core. The second toroidal core may be unwound.

Another aspect of the present is directed to a method of forming a transformer. The method may include providing a first toroidal core, winding a primary coil around a first portion of the first toroidal core, winding a secondary coil around a second portion of the first toroidal core different from the first portion, and disposing a second toroidal core within a cavity of the first toroidal core.

Another aspect of the present is directed to a method of forming a transformer. The method may include providing a first toroidal core, winding a primary coil around a first portion of the first toroidal core, winding a secondary coil around a second portion of the first toroidal core different from the first portion, and disposing a second toroidal core around the first toroidal core, wherein the first toroidal core is located within a cavity of the second toroidal core.

Another aspect of the present disclosure is directed to a transformer of a power converter. The transformer may include a first toroidal core, a primary winding around a first portion of the first toroidal core, a second toroidal core disposed within a cavity of the first toroidal core, and a secondary winding wound around an inner surface of the second toroidal core and an outer surface of a second portion of the first toroidal core, wherein the first and the second portions of the first toroidal core are different and separated by an unwound portion of the first toroidal core.

Another aspect of the present disclosure is directed to a transformer of a power converter. The transformer may include a first toroidal core; a primary winding around a first portion of the first toroidal core, a second toroidal core disposed within a cavity of the first toroidal core, and a secondary winding, comprising a first part of secondary winding around a second portion of the first toroidal core different from the first portion, and a second part of secondary winding around an inner surface of the second toroidal core and an outer surface of a third portion of the first toroidal core, wherein the first, second, and the third portions of the first toroidal core are different and separated by an unwound portion of the first toroidal core.

Another aspect of the present disclosure is directed to a transformer of a power converter. The transformer may include a first toroidal core; a primary winding around a first portion of the first toroidal core, a second toroidal core around the first toroidal core, wherein the first toroidal core is located within a cavity of the second toroidal core; and a secondary winding wound around an inner surface of a second portion of the first toroidal core and an outer surface of the second toroidal core, wherein the first and the second portions of the first toroidal core are different and separated by an unwound portion of the first toroidal core.

Another aspect of the present disclosure is directed to a transformer of a power converter. The transformer may include a first toroidal core; a primary winding around a first portion of the first toroidal core, a primary winding around a first portion of the first toroidal core, a second toroidal core around the first toroidal core, wherein the first toroidal core is located within a cavity of the second toroidal core, and a secondary winding, comprising, a first part of secondary winding around a second portion of the first toroidal core different from the first portion and a second part of secondary winding around an inner surface of a third portion of the first toroidal core and an outer surface of a portion of the second toroidal core, wherein the first, second, and the third portions of the first toroidal core are different and separated by an unwound portion of the first toroidal core.

Another aspect of the present disclosure is directed to a transformer of a power converter. The transformer may include a first toroidal core; a primary winding around a first portion of the first toroidal core, a primary winding around a the first portion of the first toroidal core, a second toroidal core substantially concentrically stacked on the first toroidal core, and a secondary winding around a portion of the second toroidal core and a second portion of the first toroidal core different from the first portion, wherein the secondary winding is continuous.

Another aspect of the present disclosure is directed to a transformer of a power converter. The transformer may include a first toroidal core; a primary winding around a first portion of the first toroidal core, a primary winding around a first portion of the first toroidal core, a second toroidal core substantially concentrically stacked on the first toroidal core, and a secondary winding, comprising a first part of secondary winding around a second portion of the first toroidal core different from the first portion and a second part of secondary winding around an inner surface of a third portion of the first toroidal core and an outer surface of a portion of the second toroidal core, wherein the first, second, and the third portions of the first toroidal core are different and separated by an unwound portion of the first toroidal core.

Another aspect of the present disclosure is directed to a transformer of a power converter. The transformer may include a first toroidal core; a primary winding around a first portion of the first toroidal core, a primary winding around a first portion of the first toroidal core, a second toroidal core placed adjacent to the first toroidal core, and a secondary winding around an inner surface of a second portion of the first toroidal core and an inner surface of a portion of the second toroidal core.

Another aspect of the present disclosure is directed to a transformer of a power converter. The transformer may include a first toroidal core; a primary winding around a first portion of the first toroidal core, a primary winding around a first portion of the first toroidal core, a second toroidal core placed adjacent to the first toroidal core, and a secondary winding, comprising a first part of secondary winding around a second portion of the first toroidal core and a second part of secondary winding around an inner surface of a third portion of the first toroidal core and an inner surface of a portion of the second toroidal core, wherein the first, second, and the third portions of the first toroidal core are different and separated by an unwound portion of the first toroidal core.

Other advantages of the embodiments of the present disclosure will become apparent from the following description taken in conjunction with the accompanying drawings wherein are set forth, by way of illustration and example, certain embodiments of the present disclosure.

### BRIEF DESCRIPTION OF FIGURES

FIG. 1 illustrates a block diagram of an exemplary system using an isolated DC-DC power converter, consistent with the embodiments of the present disclosure.

FIG. 2A illustrates an exemplary topology including a built-in series inductor in an LLC circuit, consistent with the embodiments of the present disclosure.

FIG. 2B illustrates an exemplary toroidal core transformer, consistent with the embodiments of the present disclosure.

FIG. 3 illustrates an exemplary toroidal core transformer, consistent with the embodiments of the present disclosure.

FIG. 4 illustrates an exemplary toroidal core transformer, consistent with the embodiments of the present disclosure.

FIG. 5 illustrates an exemplary toroidal core transformer, consistent with the embodiments of the present disclosure.

FIG. 6 illustrates an exemplary toroidal core transformer, consistent with the embodiments of the present disclosure.

FIG. 7A illustrates an exemplary toroidal core transformer, consistent with the embodiments of the present disclosure.

FIGS. 7B, 7C, and 7D illustrate exemplary toroidal core transformers, consistent with the embodiments of the present disclosure.

FIGS. 8A and 8B illustrate exemplary toroidal core transformers without and with a ferrite structure in the cavity, respectively, consistent with the embodiments of the present disclosure.

FIG. 9 illustrates a flow diagram of an exemplary method of forming a transformer, consistent with the embodiments of the present disclosure.

FIG. 10 illustrates a flow diagram of an exemplary method of forming a transformer, consistent with the embodiments of the present disclosure.

FIG. 11 illustrates a flow diagram of an exemplary method of forming a transformer, consistent with the embodiments of the present disclosure.

FIG. 12 illustrates a schematic of an exemplary toroidal core transformer, consistent with the embodiments of the present disclosure.

FIG. 13 illustrates a schematic of an exemplary toroidal core transformer, consistent with the embodiments of the present disclosure.

FIG. 14 illustrates a schematic of an exemplary toroidal core transformer, consistent with the embodiments of the present disclosure.

FIG. 15 illustrates a schematic of an exemplary toroidal core transformer, consistent with the embodiments of the present disclosure.

FIG. 16 illustrates a schematic of an exemplary toroidal core transformer, consistent with the embodiments of the present disclosure.

FIG. 17 illustrates a schematic of an exemplary toroidal core transformer, consistent with the embodiments of the present disclosure.

FIG. 18 illustrates a schematic of an exemplary toroidal core transformer, consistent with the embodiments of the present disclosure.

FIG. 19 illustrates a schematic of an exemplary toroidal core transformer, consistent with the embodiments of the present disclosure.

### DETAILED DESCRIPTION

Example embodiments are described herein with reference to the accompanying drawings. The figures are not necessarily drawn to scale. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used herein and in the appended claims, the singular forms “a,” “an,” and “the” include plural references unless the context clearly dictates otherwise.

Throughout this disclosure there are references to “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

In the following description, various working examples are provided for illustrative purposes. However, is to be understood the present disclosure may be practiced without one or more of these details.

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the subject matter recited in the appended claims. Without limiting the scope of the present disclosure, some embodiments may be described in the context of providing systems and methods in electric vertical takeoff and landing (eVTOL) aircrafts or aerial vehicles. However, the disclosure is not so limited. Other types of aerial vehicles such as, but not limited to, unmanned aerial vehicles (UAVs), manned aerial vehicles, conventional vertical takeoff and landing (VTOL) aircrafts, hybrid VTOLs, among other aerial vehicles, or automobiles, may utilize the systems and methods disclosed herein.

Various embodiments are described herein with reference to a structure, an assembly, or a method. It is intended that the disclosure of one is a disclosure of all. For example, it is to be understood that disclosure of a structure or an assembly described herein also constitutes a disclosure of methods for providing the structure or the assembly. It is to be understood that this form of disclosure is for ease of discussion only, and one or more aspects of one embodiment herein may be combined with one or more aspects of other embodiments herein, within the intended scope of this disclosure.

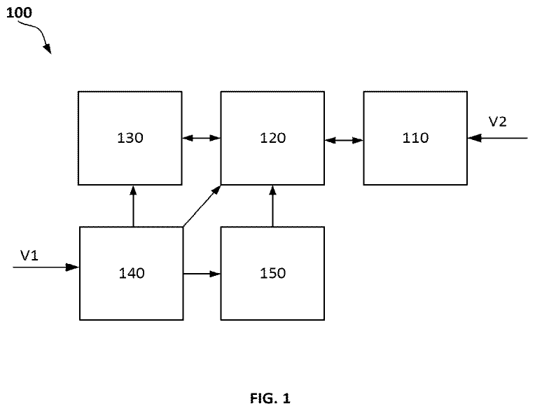

FIG. 1 illustrates a schematic of an exemplary system 100 using an isolated DC-DC power converter, consistent with the embodiments of the present disclosure. Exemplary system 100 may include an inverter power stage 110, interface circuit 120, a microcontroller stage 130, a power management integrated chip (PMIC) 140, and a power converter circuit 150.

As illustrated in FIG. 1, inverter power stage 110 may be configured to receive an input voltage V2. In some embodiments, the input voltage may be a high voltage DC input, on the order of 100V or more, 200V or more, 300V or more, 400V or more, or any suitable input voltage range. Inverter power stage 110 may be configured to convert the input DC voltage to an AC 3-phase or more signal, which may be used to power a motor, a propeller of an aircraft such as an eVTOL, an engine, or the like. Inverter power stage 110 may further be configured to receive signals including, but not limited to, pulse width modulated (PWM) signals from the interface circuit 120 and transmit sensor signals to the interface circuit 120.

Interface circuit 120 may include control circuitry, timing circuitry, protection circuitry, sensor circuitry, gate drivers, among other components. Interface circuit 120 may be configured to receive and transmit signals to inverter power stage 110. As an example, a sensor of interface circuit 120 may receive signals from inverter power stage 110, process the signal, and transmit a PWM signal to inverter power stage 110 based on the processed signal. Interface circuit 120 may further include isolated PWM signal generators, gate drivers for switches or transistors, feedback sensors, etc. Interface circuit 120 may be further configured to receive from and transmit signals to microcontroller stage 130. In some embodiments, interface circuit 120 acts as an interface block between inverter power stage 110 and microcontroller stage 130. Interface circuit 120 may be configured to isolate the grounds of power inverter stage 110 and microcontroller stage 130. In some embodiments, microcontroller stage 130 is configured to control the inverter of inverter power stage 110 and/or transmit PWM signals to interface circuit 120 and receive feedback from interface circuit 120.

In some embodiments, system 100 may include a PMIC 140 configured to regulate power consumption and supply to other components such as, but not limited to, microcontroller stage 130, interface circuit 120, or power converter circuit 150. PMIC 140 may be configured to receive a low voltage DC input signal V1 from an external power source (not illustrated). The low voltage DC input signal may include a DC voltage of 50V or lower, 40V or lower, 30V or lower, 20V or lower, 10V or lower, or any suitable voltage range. Although not illustrated in FIG. 1, in some embodiments, DC input signal V1 may be received from an external power source such as a battery or an external high-voltage to a low-voltage converter.

System 100 may include power converter circuit 150 configured to convert an input DC voltage to an output DC voltage. Power converters which convert a higher input voltage power source to a lower output voltage level are commonly known as step-down or buck converters, because the converter is “bucking” the input voltage. Power converters which convert a lower input voltage power source to a higher output voltage level are commonly known as step-up or boost converters, because the converter is “boosting” the input voltage. In addition, some power converters, commonly known as “buck-boost converters,” may be configured to convert the input voltage power source to the output voltage with a wide range, in which the output voltage may be either higher than or lower than the input voltage. In various embodiments of the present disclosure, a power converter may be bi-directional, being either a step-up or a step-down converter depending on how a power source is connected to the converter.

In some embodiments, power converter system 150 may include a transformer and may be configured to receive power from PMIC 140. Power converter system 150 may be further configured to supply power to interface circuit 120. In some embodiments, supplying power to interface circuit 120 may include supplying power to isolated PWM signal generators, gate drivers, feedback sensors, and other such components of interface circuit 120.

Toroidal transformers, i.e., transformers having a toroid-shaped core structure, typically have low leakage inductance. As used herein, and as understood by a person of ordinary skill in the art, leakage inductance in a transformer is an inductive component that results from the imperfect magnetic linking of one winding to another. In an ideal transformer, 100% of the energy is magnetically coupled from the primary to the secondary windings. Imperfect coupling reduces the signal induced in the secondary windings. In a real transformer, however, some of the flux in the primary may not link with the secondary winding. This “leakage” flux takes no part in the transformer action and may be represented as an additional inductive impedance that is in series with the primary winding. In some applications, a higher leakage inductance may be beneficial. Existing techniques in this field may suffer from one or more drawbacks such as inadequate leakage inductance, bulkiness, higher susceptibility to failure, integration issues, or poor cost-effectiveness.

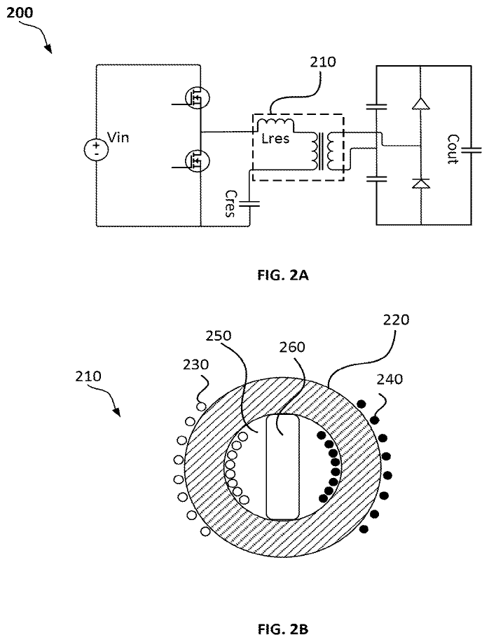

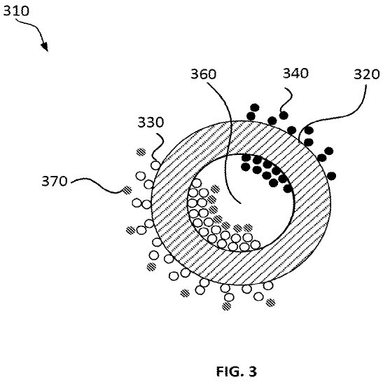

Reference is now made to FIG. 2A, which illustrates an exemplary power conversion topology including a built-in series inductor in a half-bridge LLC converter circuit 200, consistent with the embodiments of the present disclosure. Converter circuit 200 may include transformer 210 with enhanced leakage inductance, among other components. As illustrated in FIG. 2B, transformer 210 may comprise a toroidal core 220, a primary winding 230, a secondary winding 240, a cavity 250 formed by toroidal core 220, and a magnetic material 260 disposed in cavity 250 of transformer 210.

In an embodiment shown in FIG. 2B, toroidal core 220 may include a toroid-shaped core made from a magnetic material including, but not limited to, ferrites such as manganese-zinc ferrite, nickel-zinc ferrite, or the like. Ferrite core materials may exhibit high magnetic permeability and low electrical conductivity.

Transformer 210 may further include a plurality of windings or coils wound around portions of toroidal core 220. In some embodiments, transformer 210 may include primary winding 230 wound around a first portion of toroidal core 220. The number of turns, number of layers of windings, or the material of winding coil may be adjusted, as appropriate. Although exemplary transformer 210 shows a single layer of primary winding 230 with some turns, it may not be so limited. The winding coil of the primary winding may be made from an electrically conducting material including, but not limited to, copper.

Transformer 210 may further include secondary winding 240 wound around a second portion of toroidal core 220. The second portion may be different from first portion where the primary winding 230 is wound and may be separated by a portion of unwound toroidal core 220. In some embodiments, the first portion and the second portion may be diametrically opposite from each other such that the distance between the primary and the secondary windings is maximum. The increased distance between the windings may allow for higher leakage inductance while reducing the coupling efficiency of the transformer. In some embodiments, the winding coil of secondary winding 240 may be made from an electrically conducting material including, but not limited to, copper. The number of turns, number of layers of windings, or the material of the winding coil of secondary winding 240 may be similar or dissimilar to primary winding 230.

As illustrated in FIG. 2B, cavity 250 may be formed by toroidal core 220. Cavity 250 may be defined as the region or space bound by the internal surface of toroidal core 220 and having a depth defined by the height of toroidal core 220 along Z-axis (axis running in-and-out of the paper, not shown). In some embodiments, cavity 250 may include a portion of primary winding 230 and secondary winding 240 and an air gap separating the primary and the secondary windings.

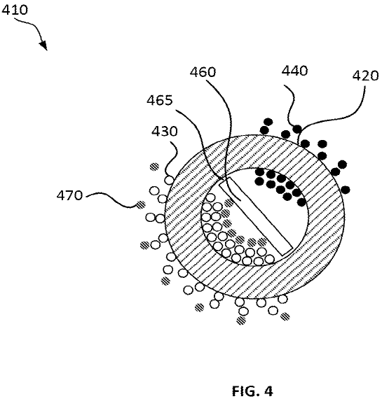

In some embodiments, transformer 210 may include a magnetic material 260 disposed in cavity 250. The magnetic material may include a ferrimagnetic material, a ferromagnetic material, a ferrite material, or a structure made from a ferrite material such as ferrite shim, a ferrite rod, a ferrite bar, or the like. It is to be appreciated that ferromagnetic materials may comprise materials that exhibit spontaneous magnetization including ferrimagnetic materials in which some magnetic moments align in the opposite direction but have a smaller contribution such that the net magnetic moment enables spontaneous magnetization. The inventors here have recognized that the leakage inductance of toroidal transformer 210 can be adjusted, as appropriate, by introducing a magnetic material in cavity 250 of toroidal core 220. FIGS. 3-7 illustrate variants of transformer 210 comprising magnetic material (e.g., ferrite material) disposed within cavity 250 that allow adjustment of the increase in leakage inductance based on the chosen design.

Non-limiting examples of magnetic material 260 disposed in cavity 250 of toroidal core 220 may include ferrites, nanocrystalline core material, amorphous core material, laminated steel sheets, silicon steel sheets, distributed air gap core, or other suitable material having a magnetic permeability greater than the magnetic permeability of air.

Reference is now made to FIG. 3, which illustrates an exemplary transformer 310, consistent with the embodiments of the present disclosure. In comparison with transformer 210, cavity of transformer 310 may be filled with a magnetic material 360 (e.g., a ferrite material). In addition, transformer 310 may include tertiary winding 370. In some embodiments, as illustrated in FIG. 3, cavity of transformer 310 may be entirely filled or substantially filled with magnetic material 360. In some other embodiments, a portion of the cavity may be filled with magnetic material 360. In some embodiments, magnetic material 360 may comprise a mixture of an epoxy material and a ferrite material. The epoxy-ferrite mixture may include ferrite powder material embedded within an epoxy matrix material. In some embodiments, the non-magnetic binding material may act as a distributed air gap.

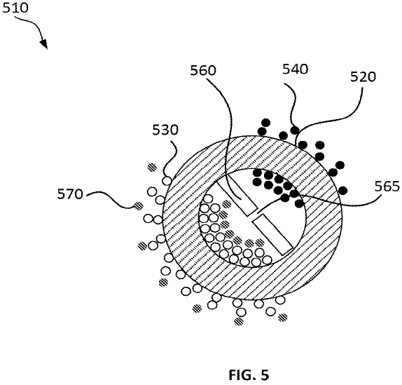

Reference is now made to FIG. 4, which illustrates an exemplary transformer 410, consistent with the embodiments of the present disclosure. In comparison with transformer 310 of FIG. 3, transformer 410 comprises a magnetic material 460 (e.g., ferrite bar). In some embodiments, as illustrated in FIG. 4, magnetic material 460 may be located such that a geometric center of the magnetic material 460 aligns with a geometric center of toroidal core 420. The length of magnetic material 460 may be smaller than the inner diameter of toroidal core 420 such that, when disposed within the cavity of transformer 410, an air gap 465 is formed between the inner surface of toroidal core 420 and an edge of magnetic material 460. Though not illustrated, in some embodiments, the length of a magnetic material may be equal to the inner diameter of the toroidal core and no air gap may be formed. In such a case, the enhancement in leakage inductance may be larger compared to the leakage inductance in transformer 410 including an air gap 465.

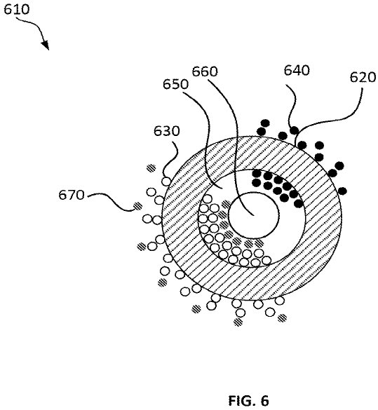

Reference is now made to FIG. 5, which illustrates an exemplary transformer 510, consistent with the embodiments of the present disclosure. In some embodiments, transformer 510 may comprise a plurality of ferrite bars. In comparison with transformer 410 of FIG. 4, transformer 510 comprises an air gap 565 separating two ferrite bars 560 (e.g., magnetic material). Air gap 565 may be aligned with the geometric center of toroidal core 520. The enhancement in leakage inductance of the toroidal core transformers (e.g., transformers 410 and 510) may be adjusted by adjusting the size and/or location of the air gaps. For example, the leakage inductance of transformer 510 with a larger air gap 565 may be smaller compared to the leakage inductance of transformer 410 with a smaller air gap 465.

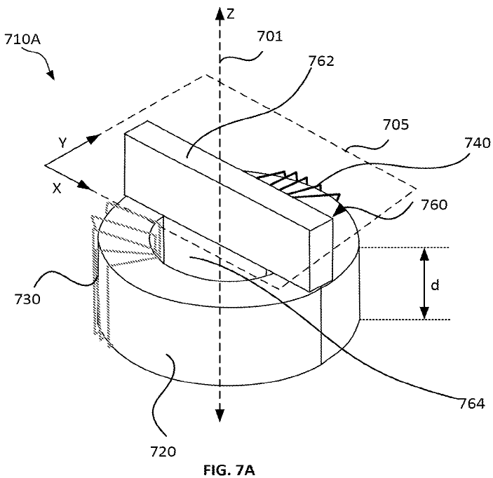

Reference is now made to FIG. 6, which illustrates an exemplary transformer 610, consistent with the embodiments of the present disclosure. In comparison with transformer 510 of FIG. 5, transformer 610 comprises a magnetic material 660 (e.g., ferrite rod) located such that the center of magnetic material 660 aligns with a geometric center of toroidal core 620. In some embodiments, magnetic material 660 may be cylindrical, or substantially cylindrical. In some embodiments, the diameter of magnetic material 660 may be adjusted to adjust the air gap between magnetic material 660 and inner surface of toroidal core 620. The adjustment of air gap between magnetic material 660 and inner surface of toroidal core 620 may allow for the adjustment of enhancement in leakage inductance, as desired. In some embodiments, the length of magnetic material 660 may be equal to or smaller than the depth of cavity 650 formed by toroidal core 620. It is to be appreciated that the length of ferrite rod may be adjusted to adjust the leakage inductance as well.

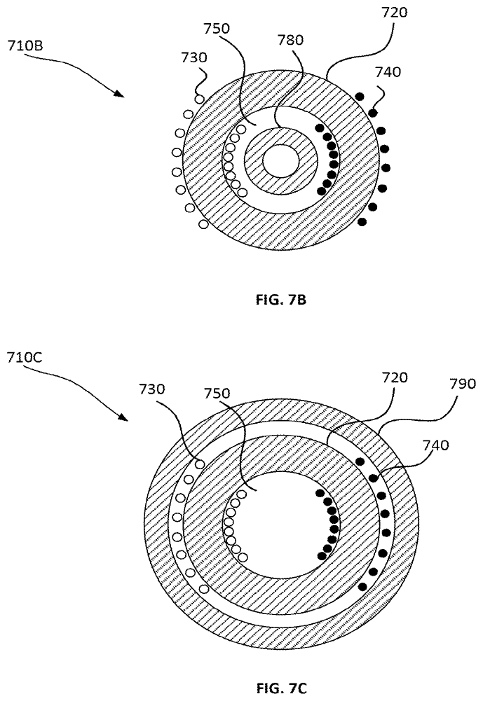

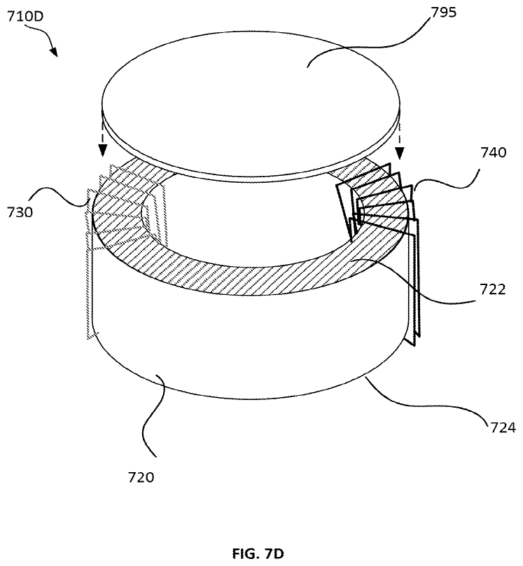

Reference is now made to FIG. 7A, which illustrates an exemplary transformer 710A, consistent with the embodiments of the present disclosure. Transformer 710A may include a plurality of ferrite bars merged to form a T-shaped magnetic material 760 (e.g., T-shaped ferrite structure) which may be formed from a single piece of ferrite substrate material by, for example, machining or any suitable material removal technique. Alternatively, magnetic material 760 may be fabricated from a monolithic ferrite substrate. In some embodiments, magnetic material 760 may comprise a first portion 762 disposed along a plane 705 (X-Y axes) perpendicular to a central axis 701 (along Z-axis) of toroidal core 720 and a second portion 764 disposed along a second plane parallel to the central axis 701 and extending along a depth of the cavity of toroidal core 720. In some embodiments, the length of first portion 762 of magnetic material 760 may be greater than the inner diameter of toroidal core 720 and equal to or less than the outer diameter of toroidal core 720. In some embodiments, second portion 764 may comprise a ferrite cylindrical rod or a ferrite rectangular bar, or a combination thereof. The width of second portion 764 may be smaller than the inner diameter of toroidal core 720 and the height of second portion 764 may be equal to or less than the depth of the cavity of toroidal core 720 or height “d” of toroidal core 720. Magnetic material 760 of transformer 710A may provide larger enhancement in leakage inductance compared to magnetic materials 460 and 560 of FIG. 4 and FIG. 5, respectively.

In some embodiments, the toroidal core and magnetic material may be fabricated from a monolithic ferrite substrate and may possess substantially similar characteristics such as, but not limited to, magnetic permeability, electrical conductivity, magnetostriction, core loss, etc. In some embodiments, the toroidal core and magnetic material may be additively manufactured, such as by using a 3-D printing technique, or may be subtractively manufactured, such as by using a substrate removal technique of milling, computerized numerical control (CNC) lathe, etching, cutting, etc. Alternatively, the toroidal core and magnetic material may be fabricated from magnetic materials having different compositions and/or characteristics.

FIG. 7B illustrates an exemplary toroidal core transformer 710B, consistent with the embodiments of the present disclosure. In addition to transformer 710A of FIG. 7A, transformer 710B includes an unwound toroidal core 780 disposed within cavity 750 of wound toroidal core 720. In some embodiments, though not illustrated, a magnetic material analogous to magnetic material 260, 360, 460, 560, 660, or 760, may be disposed within the cavity formed by second unwound toroidal core 780. The outer diameter of second unwound toroidal core 780 may be smaller than the inner diameter of wound toroidal core 720. In some embodiments, unwound toroidal core 780 may be concentric, substantially concentric, or non-concentric with wound toroidal core 720. In some embodiments, unwound toroidal core 780 may be made from a magnetic material having similar or dissimilar characteristics as the ferrite material of wound toroidal core 720.

FIG. 7C illustrates an exemplary toroidal core transformer 710C, consistent with the embodiments of the present disclosure. In comparison with transformer 710B of FIG. 7B, transformer 710C includes an unwound toroidal core 790 around wound toroidal core 720 such that toroidal core 720 is disposed within a cavity of unwound toroidal core 790. The outer diameter of wound toroidal core 720 may be smaller than the inner diameter of unwound toroidal core 790. In some embodiments, though not illustrated, a magnetic material analogous to magnetic material 260, 360, 460, 560, 660, 760, or 780, may be disposed within the cavity formed by wound toroidal core 720. In some embodiments, unwound toroidal core 790 may be concentric, substantially concentric, or non-concentric with wound toroidal core 720. In some embodiments, unwound toroidal core 790 may be made from a magnetic material having similar or dissimilar characteristics as the magnetic material of wound toroidal core 720.

Reference is now made to FIG. 7D, which illustrates an exploded view of an exemplary toroidal core transformer 710D, consistent with the embodiments of the present disclosure. Transformer 710D may include a disc-shaped magnetic structure 795 disposed on a top surface 722 of toroidal core 720 (the assembly of magnetic structure 795 with toroidal core 720 is indicated by the dashed-line arrows shown in FIG. 7D). Magnetic structure 795 may be made from a ferrite material having similar or dissimilar characteristics as the ferrite material of wound toroidal core 720. When assembled, magnetic structure 795 may be concentric or substantially concentric with toroidal core 720. In some embodiments, the diameter of magnetic structure 795 may be larger than the inner diameter of toroidal core 720. Although not illustrated, magnetic structure 795 may be circular, elliptical, rectangular, or any suitable cross-section. In some embodiments, transformer 710D may include magnetic structure 795 on both the top surface 722 and bottom surface 724. In some embodiments, though not illustrated, a magnetic material analogous to magnetic material 260, 360, 460, 560, 660, 760, or unwound toroidal cores 780 or 790 may be disposed within the cavity formed by wound toroidal core 720.

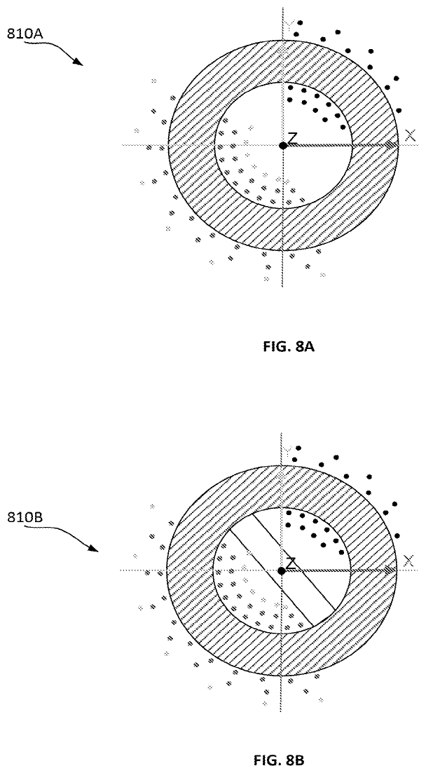

Reference is now made to FIGS. 8A and 8B, which illustrate exemplary toroidal core transformers 810A and 810B, without and with a ferrite structure in the cavity, respectively, consistent with the embodiments of the present disclosure. Transformer 810A without a ferrite structure in the cavity represents an existing method to increase the leakage inductance in power converters by separating the primary and secondary windings. Transformer 810B is an embodiment of the present invention and although transformer 810B illustrates two secondary windings, the disclosure is not so limited, and the transformers may have one or more primary windings and one or more secondary windings.

Table 1 below shows a comparison of simulated leakage inductance data between transformers 810A and 810B.

TABLE 1
Comparison of characteristics of transformers without
and with a ferrite material disposed in the cavity.

| | Transformer 810A (without | Transformer 810B (with | |
|---|---|---|---|
| | ferrite in the cavity) | ferrite in the cavity) | |
| Lₚᵣᵢ | 24.8 μH | 26.6 | μH |
| L_{sec1} | 89.4 μH | 95.4 | μH |
| L_{sec2} | 12.1 μH | 12.98 | μH |
| Coupling | 0.99 | 0.86 | |
| Coefficient_{pri-sec1} | | | |
| L_{leakage}_{_{—}}_{pri-sec1} | 0.49 μH | 6.92 | μH |

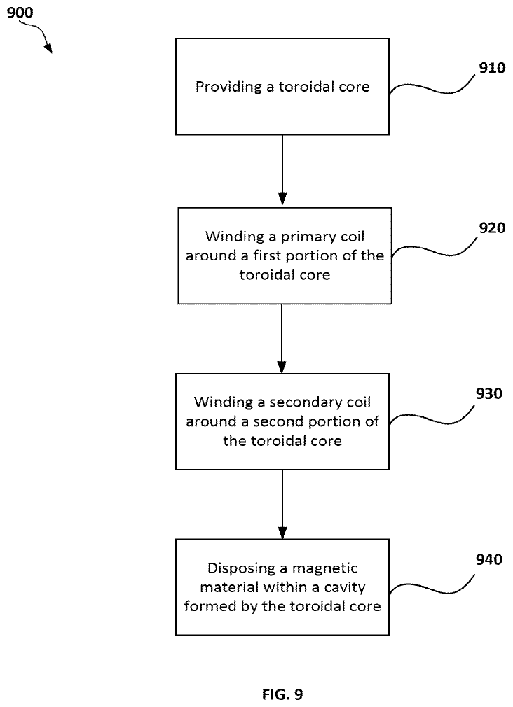

Reference is now made to FIG. 9, which is a flowchart illustrating an example method 900 of forming a transformer, consistent with embodiments of the present disclosure. The respective steps and operations of these components for method 900 are described below. It will be appreciated that the components, steps, and operations may be combined, modified, and/or rearranged depending on the application and system embodiment.

As illustrated in FIG. 9, at step 910, a toroidal core may be provided. Providing a toroidal core may include forming a toroidal core from a magnetic material such as a ferrite, for example. The toroidal core may be made from a ferromagnetic material or a ferrimagnetic material exhibiting spontaneous magnetization and with a net magnetic moment.

At step 920, a primary winding may be wound around a first portion of the toroidal core. The primary winding may include a coil of an electrically conducting material such as, but not limited to, copper. In some embodiments, one or more layers of primary winding may be wound, the number of turns may be adjusted, the material of winding may be selected, as appropriate.

At step 930, a secondary winding may be wound around a second portion of the toroidal core. The second portion is different from the first portion and in some embodiments, the first and second portions may be diametrically opposite from each other and separated by unwound portions of toroidal core. The secondary winding may include a coil of an electrically conducting material such as, but not limited to, copper.

At step 940, a magnetic material may be disposed in a cavity formed by the toroidal core. The magnetic material may comprise a ferrite material. In some embodiments, the cavity may be entirely filled or substantially filled with the ferrite material. In some embodiments, a ferrite bar or a plurality of ferrite bars may be disposed within the cavity of the toroidal core. In some embodiments, a ferrite rod or a plurality of ferrite rods may be disposed within the cavity of the toroidal core. In some embodiments, a T-shaped ferrite structure may be disposed within the cavity of the toroidal core.

In some embodiments, the ferrite bar or the ferrite rod may be placed within the cavity such that an air gap is formed between the inside surface of the toroidal core and an edge of the ferrite bar. In some embodiments, two ferrite bars may be placed or disposed such that an air gap is formed at the center of the toroidal core. The geometric center of the air gap may align with the geometric center of the toroidal core.

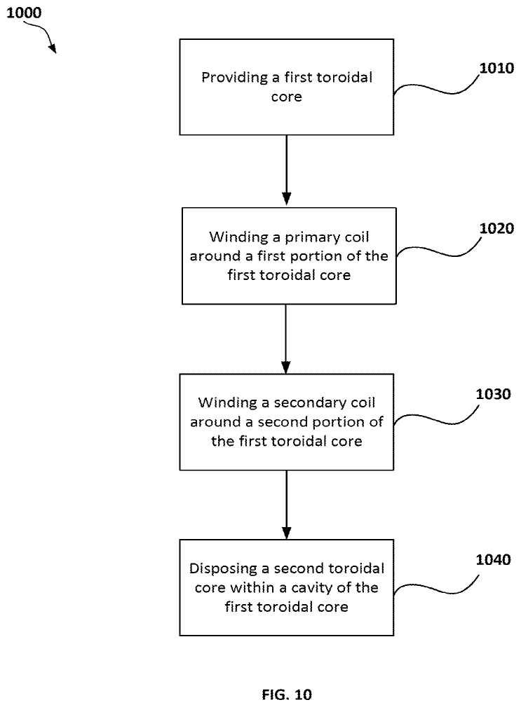

Reference is now made to FIG. 10, which is a flowchart illustrating an example method 1000 of forming a transformer, consistent with embodiments of the present disclosure. The respective steps and operations of these components for method 1000 are described below. It will be appreciated that the components, steps, and operations may be combined, modified, and/or rearranged depending on the application and system embodiment.

As illustrated in FIG. 10, at step 1010, a first toroidal core may be provided. Providing a first toroidal core may include forming a toroidal core from a magnetic material such as a ferrite, for example. The toroidal core may be made from a magnetic material, a ferromagnetic material or a ferrimagnetic material exhibiting spontaneous magnetization and with a net magnetic moment.

At step 1020, a primary winding may be wound around a first portion of the first toroidal core. The primary winding may include a coil of an electrically conducting material such as, but not limited to, copper. In some embodiments, one or more layers of primary winding may be wound, the number of turns may be adjusted, the material of winding may be selected, as appropriate.

At step 1030, a secondary winding may be wound around a second portion of the first toroidal core. The second portion is different from the first portion and in some embodiments, the first and second portions may be diametrically opposite from each other and separated by unwound portions of the first toroidal core. The secondary winding may include a coil of an electrically conducting material such as, but not limited to, copper.

At step 1040, a second toroidal core may be disposed within a cavity of the first toroidal core. The second toroidal core may be unwound. The outer diameter of second unwound toroidal core may be smaller than the inner diameter of first wound toroidal core. In some embodiments, second unwound toroidal core may be concentric, substantially concentric, or non-concentric with first wound toroidal core. In some embodiments, second unwound toroidal core may be made from a ferrite material having similar or dissimilar characteristics as the ferrite material of first wound toroidal core.

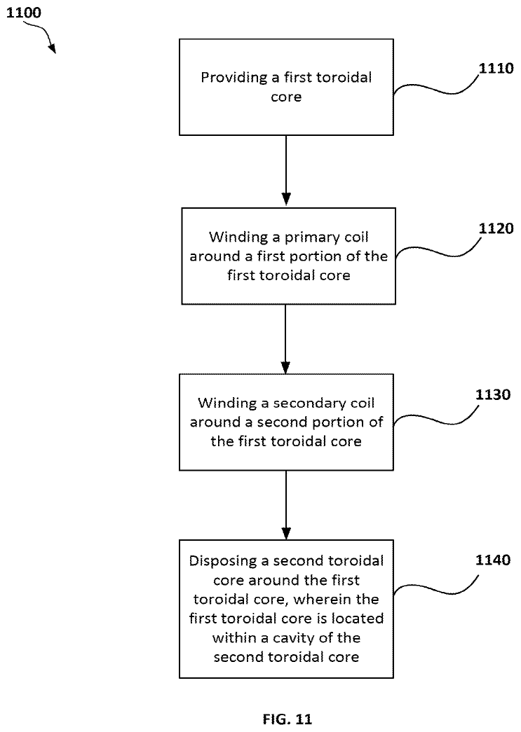

Reference is now made to FIG. 11, which is a flowchart illustrating an example method 1100 of forming a transformer, consistent with embodiments of the present disclosure. The respective steps and operations of these components for method 1100 are described below. It will be appreciated that the components, steps, and operations may be combined, modified, and/or rearranged depending on the application and system embodiment.

As illustrated in FIG. 11, at step 1110, a first toroidal core may be provided. Providing a first toroidal core may include forming a toroidal core from a magnetic material such as a ferrite, for example. The toroidal core may be made from a ferromagnetic material or a ferrimagnetic material exhibiting spontaneous magnetization and with a net magnetic moment.

At step 1120, a primary winding may be wound around a first portion of the first toroidal core. The primary winding may include a coil of an electrically conducting material such as, but not limited to, copper. In some embodiments, one or more layers of primary winding may be wound, the number of turns may be adjusted, the material of winding may be selected, as appropriate.

At step 1130, a secondary winding may be wound around a second portion of the first toroidal core. The second portion is different from the first portion and in some embodiments, the first and second portions may be diametrically opposite from each other and separated by unwound portions of the first toroidal core. The secondary winding may include a coil of an electrically conducting material such as, but not limited to, copper.

At step 1140, a second toroidal core may be disposed around the first toroidal core. The second toroidal core may be unwound. The first toroidal core may be located within a cavity of the second toroidal core. The outer diameter of first wound toroidal core may be smaller than the inner diameter of second unwound toroidal core. In some embodiments, second unwound toroidal core may be concentric, substantially concentric, or non-concentric with first wound toroidal core. In some embodiments, second unwound toroidal core may be made from a ferrite material having similar or dissimilar characteristics as the ferrite material of first wound toroidal core.

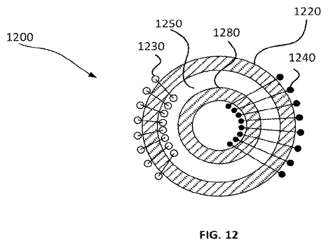

Reference is now made to FIG. 12, which illustrates a schematic of an exemplary toroidal core transformer 1200, consistent with the embodiments of the present disclosure. Toroidal core transformer 1200 may include an outer toroidal core 1220, an inner toroidal core 1280, a primary winding 1230, and a secondary winding 1240. FIG. 12 shows a cross-section view of toroidal core transformer 1200 and the lines connecting the turns in the primary and the secondary windings are for illustrative purposes only providing visual aid.

In toroidal core transformer 1200, inner toroidal core 1280 is placed within a cavity 1250 of outer toroidal core 1220. The outer diameter of inner toroidal core 1280 may be smaller than the inner diameter of outer toroidal core 1220 such that inner toroidal core 1280 is disposed, in its entirety, within the cavity 1250. Primary winding 1230 may be wound around a first portion of outer toroidal core 1220 and secondary winding 1240 may be wound around a portion of inner toroidal core 1280 and a second portion of outer toroidal core 1220. The second portion of outer toroidal core 1220 is different from the first portion of outer toroidal core 1220 and separated by an unwound portion of outer toroidal core 1220. A turn of secondary winding 1240 may be wound such that the coil winds around an inner surface of inner toroidal core 1280 and loops over and around an outer surface of outer toroidal core 1220.

In some embodiments, forming toroidal core transformer 1200 may include the following steps: (a) forming primary winding 1230 by winding primary coil around a first portion of outer toroidal core 1220; (b) placing inner toroidal core 1280 within cavity 1250; and (c) forming secondary winding 1240 by winding a secondary coil around a portion of inner toroidal core 1280 and around a second portion of outer toroidal core 1220 different from the first portion. In some embodiments, the first portion and the second portion of outer toroidal core 1220 may be diametrically opposite each other to maximize the separation between the first portion and the second portion. It is to be appreciated that the order of steps of forming toroidal core transformer 1200 is exemplary and steps may be added, removed, combined, reordered, or adjusted, as appropriate.

In some embodiments, toroidal core transformer 1200 may comprise one or more primary windings and one or more secondary windings. In some embodiments, the number of turns of primary and secondary windings may be equal, or individually varied, as appropriate.

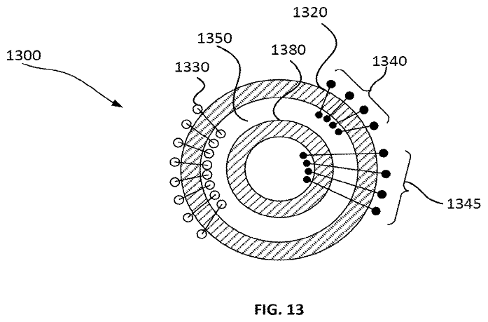

Reference is now made to FIG. 13, which illustrates a schematic of an exemplary toroidal core transformer 1300, consistent with the embodiments of the present disclosure. Toroidal core transformer 1300 may include an outer toroidal core 1320, an inner toroidal core 1380, a primary winding 1330, and a first part of secondary winding 1340, and a second part of secondary winding 1345. FIG. 13 shows a cross-section view of toroidal core transformer 1300 and the lines connecting the turns in the primary and the secondary windings are for illustrative purposes only providing visual aid.

In toroidal core transformer 1300, inner toroidal core 1380 is placed within a cavity 1350 of outer toroidal core 1320. The outer diameter of inner toroidal core 1380 may be smaller than the inner diameter of outer toroidal core 1320 such that inner toroidal core 1380 is disposed, in its entirety, within the cavity 1350. Primary winding 1330 may be wound around a first portion of outer toroidal core 1320, first part of secondary winding 1340 may be wound around a second portion of outer toroidal core 1320, and a second part of secondary winding 1345 may be wound around a third portion of outer toroidal core 1320. The first, second, and third portions of outer toroidal core 1320 may be different from each other and separated by an unwound portion of outer toroidal core 1320.

In some embodiments, forming toroidal core transformer 1300 may include the following steps: (a) forming primary winding 1330 by winding primary coil around a first portion of outer toroidal core 1320; (b) forming first secondary winding 1340 by winding a secondary coil around a second portion of outer toroidal core 1320; (c) placing inner toroidal core 1380 within cavity 1350; and (d) forming second part of secondary winding 1345 by winding a secondary coil around a portion of inner toroidal core 1380 and around a third portion of outer toroidal core 1320 different from the first and the second portions. In some embodiments, the first, second, and the third portions of outer toroidal core 1320 may be separated by unwound portions of outer toroidal core 1320. It is to be appreciated that the order of steps of forming toroidal core transformer 1300 is exemplary and steps may be added, removed, combined, reordered, or adjusted, as appropriate. It is to be further appreciated that although the number of turns in first part of secondary winding and second part of secondary winding are shown equal, they may be different as well, as appropriate.

In some embodiments, toroidal core transformer 1300 may comprise one or more primary windings and one or more secondary windings. In some embodiments, the number of turns of primary and secondary windings may be equal, or individually varied, as appropriate.

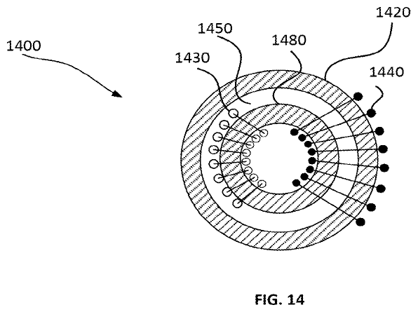

Reference is now made to FIG. 14, which illustrates a schematic of an exemplary toroidal core transformer 1400, consistent with the embodiments of the present disclosure. Toroidal core transformer 1400 may include an outer toroidal core 1420, an inner toroidal core 1480, a primary winding 1430, and a secondary winding 1440. FIG. 14 shows a cross-section view of toroidal core transformer 1400 and the lines connecting the turns in the primary and the secondary windings are for illustrative purposes only providing visual aid.

In toroidal core transformer 1400, outer toroidal core 1420 may be placed around inner toroidal core 1480 such that inner toroidal core 1480 lies within a cavity 1450 of outer toroidal core 1420. The outer diameter of inner toroidal core 1480 may be smaller than the inner diameter of outer toroidal core 1420. Primary winding 1430 may be wound around a first portion of outer toroidal core 1420 and secondary winding 1440 may be wound around a portion of inner toroidal core 1480 and a second portion of outer toroidal core 1420. The second portion of outer toroidal core 1420 is different from the first portion of outer toroidal core 1420 and separated by an unwound portion of outer toroidal core 1420. A turn of secondary winding 1440 may be wound such that the coil winds around an inner surface of inner toroidal core 1480 and loops over and around an outer surface of outer toroidal core 1420.

In some embodiments, forming toroidal core transformer 1400 may include the following steps: (a) forming primary winding 1430 by winding primary coil around inner toroidal core 1480; (b) placing outer toroidal core 1420 around inner toroidal core 1480 such that inner toroidal core 1480 is within cavity 1450 of outer toroidal core 1420; and (c) forming secondary winding 1440 by winding a secondary coil around a portion of inner toroidal core 1480 and around a portion of outer toroidal core 1420. It is to be appreciated that the order of steps of forming toroidal core transformer 1400 is exemplary and steps may be added, removed, combined, reordered, or adjusted, as appropriate.

In some embodiments, toroidal core transformer 1400 may comprise one or more primary windings and one or more secondary windings. In some embodiments, the number of turns of primary and secondary windings may be equal, or individually varied, as appropriate.

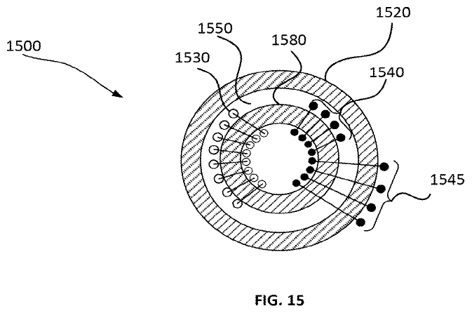

Reference is now made to FIG. 15, which illustrates a schematic of an exemplary toroidal core transformer 1500, consistent with the embodiments of the present disclosure. Toroidal core transformer 1500 may include an outer toroidal core 1520, an inner toroidal core 1580, a primary winding 1530, a first part of secondary winding 1540, and a second part of secondary winding 1545. FIG. 15 shows a cross-section view of toroidal core transformer 1500 and the lines connecting the turns in the primary and the secondary windings are for illustrative purposes only providing visual aid.

In toroidal core transformer 1500, outer toroidal core 1520 may be placed around inner toroidal core 1580 such that inner toroidal core 1580 lies within a cavity 1550 of outer toroidal core 1520. The outer diameter of inner toroidal core 1580 may be smaller than the inner diameter of outer toroidal core 1520. Primary winding 1530 may be wound around a first portion of inner toroidal core 1580, first part of secondary winding 1540 may be wound around a second portion of inner toroidal core 1520, the second portion of inner toroidal core 1580 being different from the first portion of inner toroidal core 1580. A second part of secondary winding 1545 may be wound around a portion of outer toroidal core 1520 and an inner surface of inner toroidal core 1580, as illustrated in FIG. 15. The first and second portions of inner toroidal core 1580 may be different from each other and separated by an unwound portion of inner toroidal core 1580.

In some embodiments, forming toroidal core transformer 1500 may include the following steps: (a) forming primary winding 1530 by winding primary coil around a first portion of inner toroidal core 1580; (b) forming a partial or first part of secondary winding 1540 by winding a secondary coil around a second portion of inner toroidal core 1580; (c) placing outer toroidal core 1520 around inner toroidal core 1580 such that inner toroidal core 1580 lies within cavity 1550 of outer toroidal core 1520; and (d) forming the remaining or second part of secondary winding 1545 by winding a secondary coil around a third portion of inner toroidal core 1580 and around a portion of outer toroidal core 1520. In some embodiments, the first, second, and the third portions of inner toroidal core 1580 may be separated by unwound portions of inner toroidal core 1580. It is to be appreciated that the order of steps of forming toroidal core transformer 1500 is exemplary and steps may be added, removed, combined, reordered, or adjusted, as appropriate. It is to be further appreciated that although the number of turns in first part of secondary winding and second part of secondary winding are shown equal, they may be different as well, as appropriate.

In some embodiments, toroidal core transformer 1500 may comprise one or more primary windings and one or more secondary windings. In some embodiments, the number of turns of primary and secondary windings may be equal, or individually varied, as appropriate.

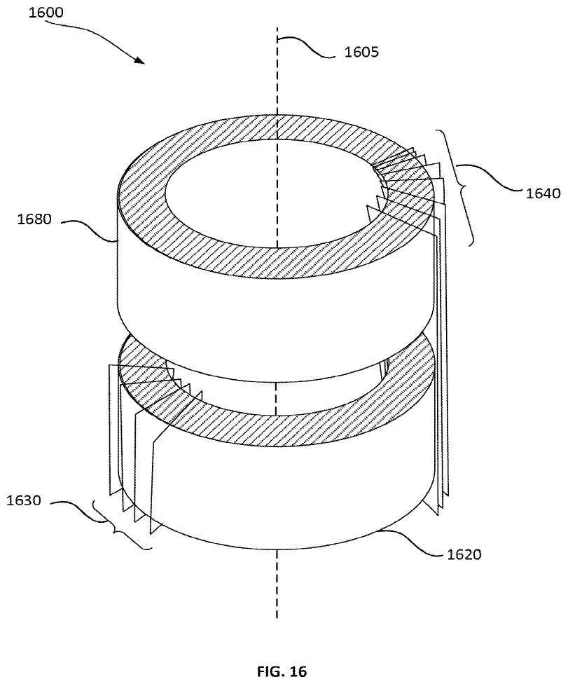

Reference is now made to FIG. 16, which illustrates a schematic of an exemplary toroidal core transformer 1600, consistent with the embodiments of the present disclosure. Toroidal core transformer 1600 may include a first toroidal core 1620, a second toroidal core 1680, a primary winding 1630, and a secondary winding 1640. FIG. 16 shows a perspective view of toroidal core transformer 1600.

In toroidal core transformer 1600, primary winding 1630 may be wound around a portion of first toroidal core 1620. It is to be appreciated that although only four turns of the primary winding are illustrated in primary winding 1630, any number of turns may be applied, as appropriate. Second toroidal core 1680 may be placed concentrically or substantially concentrically with first toroidal core 1620. As used herein, concentric refers to an arrangement of the toroidal cores such that the geometric center of each toroidal core is aligned with the central axis or the symmetry axis, e.g., central axis 1605 along a Z-axis. In some embodiments, second toroidal core 1680 may be placed on top of first toroidal core 1620 (as illustrated in FIG. 16) in a stacked arrangement. Alternatively, first toroidal core 1620 may be placed on top of second toroidal core 1680 in a stacked arrangement. In some embodiments, the outer diameter of second toroidal core 1680 placed on first toroidal core 1620 may be equal to or larger than the inner diameter of first toroidal core 1620. In some embodiments, the inner diameter of second toroidal core 1680 may be equal to or smaller than the outer diameter of first toroidal core 1620. The thickness of first and second toroidal cores may be adjusted, as appropriate. As used herein, thickness of a toroidal core is referred to as the difference between the outer and the inner diameter.

In toroidal core transformer 1600, secondary winding 1640 may be wound around first and second toroidal cores after placing second toroidal core 1680 atop first toroidal core 1620 such that secondary winding 1640 is wound continuously around inner surfaces of first and second toroidal cores, looping over, and around outer surfaces of the first toroidal core 1620 and second toroidal core 1680. In some embodiments, the leakage inductance of toroidal core transformer 1600 may be 30× or higher, or 40× or higher, or 50× or higher compared to the leakage inductance of a conventional single toroidal core transformer having separation between the primary and secondary windings.

In some embodiments, forming toroidal core transformer 1600 may include the following steps: (a) forming primary winding 1630 by winding a primary coil around a portion of first toroidal core 1620; (b) placing second toroidal core 1680 concentrically or substantially concentrically with first toroidal core 1620; and (c) forming secondary winding 1640 by winding a secondary coil around first and second toroidal cores after placing second toroidal core 1680 such that secondary winding 1640 is wound continuously around inner surfaces of first and second toroidal cores, looping over, and around outer surfaces of the first toroidal core 1620 and second toroidal core 1680. It is to be appreciated that the order of steps of forming toroidal core transformer 1600 is exemplary and steps may be added, removed, combined, reordered, or adjusted, as appropriate.

In some embodiments, toroidal core transformer 1600 may comprise one or more primary windings and one or more secondary windings. In some embodiments, the number of turns of primary and secondary windings may be equal, or individually varied, as appropriate.

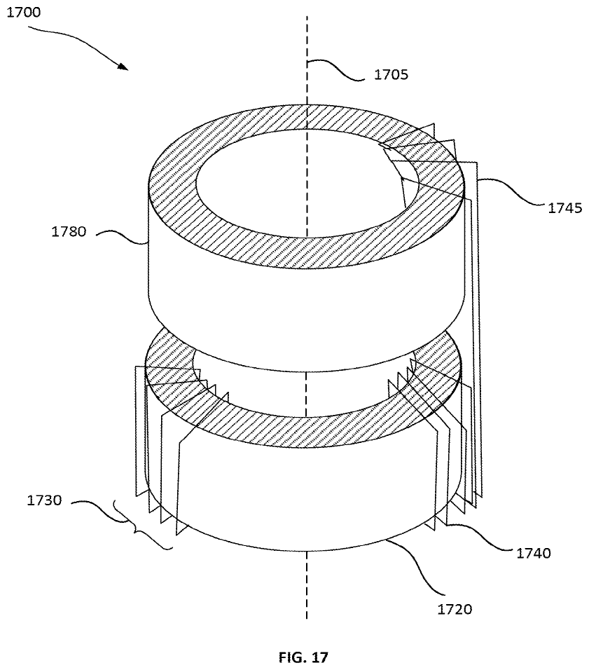

Reference is now made to FIG. 17, which illustrates a schematic of an exemplary toroidal core transformer 1700, consistent with the embodiments of the present disclosure. Toroidal core transformer 1700 may include a first toroidal core 1720, a second toroidal core 1780, a primary winding 1730, a first part of secondary winding 1740, and a second part of secondary winding 1745. FIG. 17 shows a perspective view of toroidal core transformer 1700.

In toroidal core transformer 1700, primary winding 1730 may be wound around a first portion of first toroidal core 1720 and first part of secondary winding 1740 may be wound around a second portion of first toroidal core 1720, the first and the second portions being different and separated by unwound portions of the toroidal core. It is to be appreciated that although only four turns of the primary and secondary windings are illustrated, any number of turns may be applied, as appropriate. Second toroidal core 1780 may be placed concentrically or substantially concentrically with first toroidal core 1720. As used herein, concentric refers to an arrangement of the toroidal cores such that the geometric center of each toroidal core is aligned with the central axis or the symmetry axis, e.g., central axis 1705 along a Z-axis. In some embodiments, second toroidal core 1780 may be placed on top of first toroidal core 1720 (as illustrated in FIG. 17) in a stacked arrangement. Alternatively, first toroidal core 1720 may be placed on top of second toroidal core 1780 in a stacked arrangement. In some embodiments, the outer diameter of second toroidal core 1780 placed on first toroidal core 1720 may be equal to or larger than the inner diameter of first toroidal core 1720. In some embodiments, the inner diameter of second toroidal core 1780 may be equal to or smaller than the outer diameter of first toroidal core 1720. The thickness of first and second toroidal cores may be adjusted, as appropriate.

In toroidal core transformer 1700, second part of secondary winding 1745 may be wound around first and second toroidal cores after placing second toroidal core 1780 atop first toroidal core 1720 such that secondary winding 1745 is wound continuously around inner surfaces of first and second toroidal cores, looping over, and around outer surfaces of the first toroidal core 1720 and second toroidal core 1780. In some embodiments, the leakage inductance of toroidal core transformer 1700 may be 30× or higher, or 40× or higher, or 50× or higher compared to the leakage inductance of a conventional single toroidal core transformer having separation between the primary and secondary windings.

In some embodiments, forming toroidal core transformer 1700 may include the following steps: (a) forming primary winding 1730 by winding a primary coil around a first portion of first toroidal core 1720; (b) forming first part of secondary winding 1740 by winding a secondary coil around a second portion of first toroidal core 1720, the first and second portions being different and separated by unwound portions of the toroidal core; (c) placing second toroidal core 1780 concentrically or substantially concentrically with first toroidal core 1720; and (d) forming second part of secondary winding 1745 by winding the secondary coil around first and second toroidal cores after placing second toroidal core 1780. The second part of secondary winding 1745 may be wound continuously around inner surfaces of first and second toroidal cores, looping over, and around outer surfaces of the first toroidal core 1720 and second toroidal core 1780.

In some embodiments, toroidal core transformer 1700 may comprise one or more primary windings and one or more secondary windings. In some embodiments, the number of turns of primary and secondary windings may be equal, or individually varied, as appropriate.

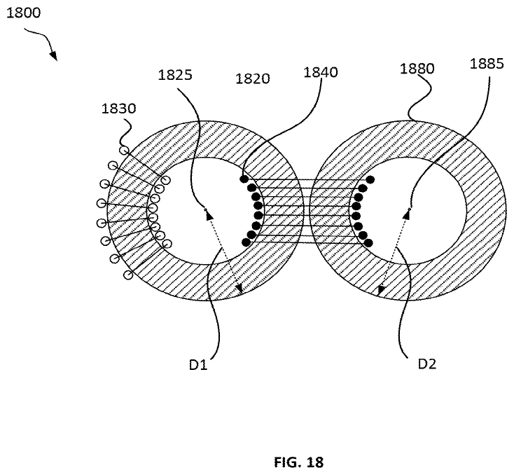

Reference is now made to FIG. 18, which illustrates a schematic of an exemplary toroidal core transformer 1800, consistent with the embodiments of the present disclosure. Toroidal core 1800 may include a first toroidal core 1820, a second toroidal core 1880 placed adjacent first toroidal core 1820, a primary winding 1830, and a secondary winding 1840. FIG. 18 shows a cross-section view of toroidal core transformer 1800 and the lines connecting the turns in the primary and the secondary windings are for illustrative purposes only providing visual aid.

In toroidal core transformer 1800, primary winding 1830 may be wound around a portion of first toroidal core 1820. It is to be appreciated that although only eight turns of the primary winding are illustrated in primary winding 1830, any number of turns may be applied, as appropriate. Second toroidal core 1880 may be placed adjacent first toroidal core 1820 such that their central axes (running in-out of the paper along Z-axis) passing through the geometric centers 1825 and 1885, respectively, are substantially parallel to each other and radially separated. Second toroidal core 1880 may not overlap with first toroidal core 1820. In some embodiments, first and second toroidal cores may be placed adjacent to each other such that their geometric centers 1825 and 1885 are separated by a distance equal to or larger than the sum of their outer diameters D1 and D2, respectively.

In toroidal core transformer 1800, secondary winding 1840 may be wound around first and second toroidal cores after placing second toroidal core 1880 adjacent first toroidal core 1820 such that secondary winding 1840 is wound continuously around a portion of inner surfaces of first toroidal core 1820 and second toroidal core 1880. The secondary winding 1840 may be wound around a second portion of first toroidal core 1820 different from the first portion including primary winding 1830 and separated by unwound portions of first toroidal core 1820.

In some embodiments, forming toroidal core transformer 1800 may include the following steps: (a) forming primary winding 1830 by winding a primary coil around a first portion of first toroidal core 1820; (b) placing second toroidal core 1880 adjacent first toroidal core 1820; and (c) forming secondary winding 1840 by winding a secondary coil around first and second toroidal cores after placing second toroidal core 1880 such that secondary winding 1840 is wound continuously around inner surfaces of first toroidal core 1820 and second toroidal core 1880. It is to be appreciated that the order of steps of forming toroidal core transformer 1800 is exemplary and steps may be added, removed, combined, reordered, or adjusted, as appropriate.

In some embodiments, toroidal core transformer 1800 may comprise one or more primary windings and one or more secondary windings. In some embodiments, the number of turns of primary and secondary windings may be equal, or individually varied, as appropriate.

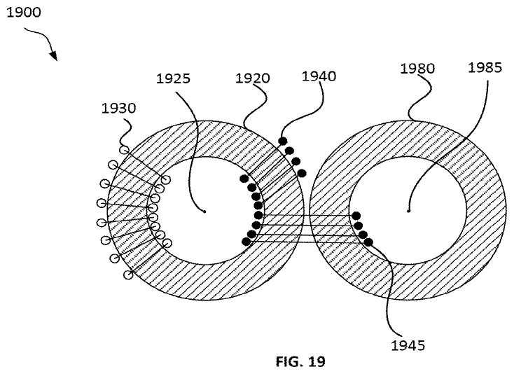

Reference is now made to FIG. 19, which illustrates a schematic of an exemplary toroidal core transformer 1900, consistent with the embodiments of the present disclosure. Toroidal core transformer 1900 may include a first toroidal core 1920, a second toroidal core 1980 placed adjacent first toroidal core 1920, a primary winding 1930, a first secondary winding 1940, and a second part of secondary winding 1945. FIG. 19 shows a cross-section view of toroidal core transformer 1900 and the lines connecting the turns in the primary and the secondary windings are for illustrative purposes only providing visual aid.

In toroidal core transformer 1900, primary winding 1930 may be wound around a first portion of first toroidal core 1920 and first part of secondary winding 1940 may be wound around a second portion of first toroidal core 1920, the first and the second portions being different and separated by unwound portions of first toroidal core 1920. It is to be appreciated that any number of turns in the primary and the secondary windings may be applied, as appropriate. Second toroidal core 1980 may be placed adjacent first toroidal core 1920 such that their central axes (running in-out of the paper along Z-axis) passing through the geometric centers 1925 and 1985, respectively, are substantially parallel to each other and radially separated. Second toroidal core 1980 may not overlap with first toroidal core 1920.

In toroidal core transformer 1900, second part of secondary winding 1945 may be wound around first and second toroidal cores after placing second toroidal core 1980 adjacent first toroidal core 1920 such that second part of secondary winding 1945 is wound continuously around inner surfaces of first toroidal core 1920 and second toroidal core 1920.

In some embodiments, forming toroidal core transformer 1900 may include the following steps: (a) forming primary winding 1930 by winding a primary coil around a first portion of first toroidal core 1920; (b) forming first part of secondary winding 1940 by winding a secondary coil around a second portion of first toroidal core 1920, the first and second portions being different and separated by unwound portions of the toroidal core; (c) placing second toroidal core 1980 adjacent first toroidal core 1920; and (d) forming second part of secondary winding 1945 by winding the secondary coil around inner surfaces of first and second toroidal cores after placing second toroidal core 1980. The second part of secondary winding 1945 may be wound continuously around inner surfaces of first toroidal core 1920 and second toroidal core 1980.

In some embodiments, toroidal core transformer 1900 may comprise one or more primary windings and one or more secondary windings. In some embodiments, the number of turns of primary and secondary windings may be equal, or individually varied, as appropriate.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the inventions disclosed herein.

The following clauses set out a number of non-limiting aspects of the present disclosure:
1. A transformer of a power converter, the transformer comprising:
   a toroidal core;
   a primary winding around a first portion of the toroidal core;
   a secondary winding around a second portion of the toroidal core different from the first portion; and
   a magnetic material disposed within a cavity formed by the toroidal core.
2. The transformer of clause 1, wherein the first and the second portions are diametrically opposite from each other.
3. The transformer of any of clauses 1 or 2, wherein the cavity is filled with the magnetic material comprising a ferrite structure.
4. The transformer of clause 3, wherein the ferrite structure comprises a ferrite bar.
5. The transformer of clause 4, wherein the ferrite bar is located such that a geometric center of the ferrite bar aligns with a geometric center of the toroidal core.
6. The transformer of any of clauses 4 or 5, wherein a length of the ferrite bar is smaller than an inner diameter of the toroidal core.
7. The transformer of any of clauses 4 to 6, wherein the ferrite bar is located such that an air gap is formed between an inner surface of the toroidal core and an edge of the ferrite bar.
8. The transformer of any of clauses 4 or 5, wherein a length of the ferrite bar is equal to an inner diameter of the toroidal core.
9. The transformer of clause 3, wherein the ferrite structure comprises a ferrite rod.
10. The transformer of clause 9, wherein a center of the ferrite rod aligns with a geometric center of the toroidal core.
11. The transformer of clause 3, wherein the ferrite structure comprises a plurality of ferrite bars.
12. The transformer of clause 11, wherein a first bar and a second bar of the plurality of ferrite bars are disposed diametrically opposite to each other, and wherein the first and the second bars are separated by an air gap.
13. The transformer of clause 12, wherein a center of the air gap aligns with a geometric center of the toroidal core.
14. The transformer of clause 3, wherein the ferrite structure comprises:
a first portion disposed along a first plane perpendicular to a central axis of the toroidal core; and
a second portion disposed along a second plane parallel to the central axis and extending along a depth of the cavity.
15. The transformer of clause 14, wherein a length of the first portion of the ferrite structure is greater than an inner diameter of the toroidal core.
16. The transformer of clause 3, wherein the toroidal core and the ferrite structure are fabricated from a monolithic ferrite substrate.
17. The transformer of clause 3, wherein the toroidal core and the ferrite structure are additively manufactured using a 3-D printing technique.
18. A method of forming a transformer, the method comprising:
   providing a toroidal core;
   winding a primary coil around a first portion of the toroidal core;
   winding a secondary coil around a second portion of the toroidal core different from the first portion; and
   disposing a magnetic material in a cavity formed by the toroidal core, wherein the magnetic material in the cavity enhances a leakage inductance of the transformer.
19. The method of clause 18, wherein the magnetic material comprises a ferrite structure.
20. The method of clause 19, wherein the ferrite structure comprises a ferrite rod, a ferrite bar, a ferrite shim, a plurality of ferrite bars, or a plurality of ferrite rods.
21. A transformer of a power converter, the transformer comprising:
   a first toroidal core;
   a primary winding around a first portion of the first toroidal core;
   a secondary winding wound around a second portion of the first toroidal core different from the first portion; and
   a second toroidal core disposed within a cavity of the first toroidal core.
22. The transformer of clause 21, wherein the second toroidal core is unwound.
23. The transformer of any of clauses 21 or 22, further comprising a plurality of primary windings.
24. The transformer of any of clauses 21 to 23, further comprising a plurality of secondary windings.
25. The transformer of any of clauses 21 to 24, wherein the second toroidal core is concentric with the first toroidal core.
26. The transformer of any of clauses 21 to 25, wherein the first toroidal core and the second toroidal core are made from a ferrite material.
27. The transformer of any of clauses 21 to 24, wherein the second toroidal core is non-concentric with the first toroidal core.
28. A transformer of a power converter, the transformer comprising:
   a first toroidal core;
   a primary winding around a first portion of the first toroidal core;
   a secondary winding wound around a second portion of the first toroidal core different from the first portion; and
   a second toroidal core disposed around the first toroidal core, such that the first toroidal core is located within a cavity of the second toroidal core.
29. The transformer of clause 28, wherein the second toroidal core is unwound.
30. The transformer of any of clauses 28 or 29, further comprising a plurality of primary windings.
31. The transformer of any of clauses 28 to 30, further comprising a plurality of secondary windings.
32. The transformer of any of clauses 28 to 31, wherein the second toroidal core is non-concentric with the first toroidal core.
33. The transformer of any of clauses 28 to 32, wherein the first toroidal core and the second toroidal core are made from a ferrite material.
34. The transformer of any of clauses 28 to 31, wherein the second toroidal core is concentric with the first toroidal core.
35. A method of forming a transformer, the method comprising:
   providing a first toroidal core;
   winding a primary coil around a first portion of the first toroidal core;
   winding a secondary coil around a second portion of the first toroidal core different from the first portion; and
   disposing a second toroidal core within a cavity of the first toroidal core.
36. A method of forming a transformer, the method comprising:
   providing a first toroidal core;
   winding a primary coil around a first portion of the first toroidal core;
   winding a secondary coil around a second portion of the first toroidal core different from the first portion; and
   disposing a second toroidal core around the first toroidal core such that the first toroidal core is located within a cavity of the second toroidal core.
37. A transformer of a power converter, the transformer comprising:
a first toroidal core;
   a primary winding around a first portion of the first toroidal core;
   a second toroidal core disposed within a cavity of the first toroidal core; and
   a secondary winding wound around an inner surface of the second toroidal core and an outer surface of a second portion of the first toroidal core, wherein the first and the second portions of the first toroidal core are different and separated by an unwound portion of the first toroidal core.
38. A transformer of a power converter, the transformer comprising:
   a first toroidal core;
   a primary winding around a first portion of the first toroidal core;
   a second toroidal core disposed within a cavity of the first toroidal core; and
   a secondary winding, comprising:
   a first part of secondary winding around a second portion of the first toroidal core different from the first portion; and
   a second part of secondary winding around an inner surface of the second toroidal core and an outer surface of a third portion of the first toroidal core, wherein the first, second, and the third portions of the first toroidal core are different and separated by unwound portions of the first toroidal core.
39. A transformer of a power converter, the transformer comprising:
   a first toroidal core;
   a primary winding around a first portion of the first toroidal core;
   a second toroidal core disposed around the first toroidal core, such that the first toroidal core is located within a cavity of the second toroidal core; and
   a secondary winding wound around an inner surface of a second portion of the first toroidal core and an outer surface of the second toroidal core, wherein the first and the second portions of the first toroidal core are different and separated by an unwound portion of the first toroidal core.
40. A transformer of a power converter, the transformer comprising:
   a first toroidal core;
   a primary winding around a first portion of the first toroidal core;
   a second toroidal core disposed around the first toroidal core such that the first toroidal core is located within a cavity of the second toroidal core; and
   a secondary winding, comprising:
   a first part of secondary winding around a second portion of the first toroidal core different from the first portion; and
   a second part of secondary winding around an inner surface of a third portion of the first toroidal core and an outer surface of a portion of the second toroidal core, wherein the first, second, and the third portions of the first toroidal core are different and separated by unwound portions of the first toroidal core.
41. A transformer of a power converter, the transformer comprising:
   a first toroidal core;
   a primary winding around a the first portion of the first toroidal core;
   a second toroidal core substantially concentrically stacked on the first toroidal core; and
   a secondary winding around a portion of the second toroidal core and a second portion of the first toroidal core different from the first portion, wherein the secondary winding is continuous.
42. A transformer of a power converter, the transformer comprising:
   a first toroidal core;
   a primary winding around a first portion of the first toroidal core;
   a second toroidal core substantially concentrically stacked on the first toroidal core; and
   a secondary winding, comprising:
   a first part of secondary winding around a second portion of the first toroidal core different from the first portion; and
   a second part of secondary winding around an inner surface of a third portion of the first toroidal core and an outer surface of a portion of the second toroidal core, wherein the first, second, and the third portions of the first toroidal core are different and separated by unwound portions of the first toroidal core.
43. A transformer of a power converter, the transformer comprising:
   a first toroidal core;
   a primary winding around a first portion of the first toroidal core;
   a second toroidal core placed adjacent to the first toroidal core; and
   a secondary winding around an inner surface of a second portion of the first toroidal core and an inner surface of a portion of the second toroidal core.
44. A transformer of a power converter, the transformer comprising:
   a first toroidal core;
   a primary winding around a first portion of the first toroidal core;
   a second toroidal core placed adjacent to the first toroidal core; and
   a secondary winding, comprising:
   a first part of secondary winding around a second portion of the first toroidal core; and
   a second part of secondary winding around an inner surface of a third portion of the first toroidal core and an inner surface of a portion of the second toroidal core, wherein the first, second, and the third portions of the first toroidal core are different and separated by unwound portions of the first toroidal core.
45. A power converter comprising the transformer of any of clauses 1 to 17, 21 to 34, or 37 to 44.

1-34. (canceled)

35. A transformer, the transformer comprising:
a first toroidal core;
a second toroidal core that is concentric with the first toroidal core and disposed within a cavity of the first toroidal core;
wherein at least one of the first toroidal core or the second toroidal core comprises:
a primary winding around a first portion of the at least one toroidal core;
a secondary winding wound around a second portion of the at least one toroidal core different from the first portion.

36. The transformer of claim 35, wherein the second toroidal core is unwound and the first toroidal core comprises the primary winding and the secondary winding.

37. The transformer of claim 35, wherein the first toroidal core is unwound and the second toroidal core comprises the primary winding and the secondary winding.

38. The transformer of claim 35, further comprising a plurality of primary windings.

39. The transformer of claim 35, further comprising a plurality of secondary windings.

40. The transformer of claim 35, wherein the first toroidal core and the second toroidal core are made from a same type of ferrite material.

41. The transformer of claim 35, wherein the first toroidal core and the second toroidal core are made from a different type of ferrite material.

42. The transformer of claim 35, wherein the primary winding is around the second toroidal core and the secondary winding is around both the first toroidal core and the second toroidal core.

43. The transformer of claim 35, wherein the primary winding is around the first toroidal core and the secondary winding is around both the first toroidal core and the second toroidal core.

44. The transformer of claim 35, wherein the primary winding is around the second toroidal core and the secondary winding comprises windings around only the second toroidal core and windings around both the first toroidal core and the second toroidal core.

45. The transformer of claim 35, wherein the primary winding is around the first toroidal core and the secondary winding comprises windings around only the second toroidal core and windings around both the first toroidal core and the second toroidal core.

46. The transformer of claim 35, wherein the second toroidal comprises a cavity.

47. The transformer of claim 35, wherein the primary winding and the secondary winding provide leakage inductance.

48. The transformer of claim 35, further comprising a magnetic material disposed within the cavity of the first toroidal core, wherein the magnetic material enhances a leakage inductance of the transformer.

49. The transformer of claim 35, wherein the transformer is used in at least one component of a vehicle.

50. The transformer of claim 49, wherein the vehicle comprises an aircraft.

51. An aircraft, the aircraft comprising:
a transformer, the transformer comprising:
a first toroidal core;
a second toroidal core that is concentric with the first toroidal core and disposed within a cavity of the first toroidal core;
wherein at least one of the first toroidal core or the second toroidal core comprises:
a primary winding around a first portion of the at least one toroidal core;
a secondary winding wound around a second portion of the at least one toroidal core different from the first portion.
